(19) United States
(12) Patent Application Publication
(10) Pub. No.: US 2006/0290732 A1
(43) Pub. Date: Dec. 28, 2006

(54) Ink-jet image forming apparatus and high resolution printing method

(75) Inventors: Seong-il Park, Suwon-si (KR); Jong-un Jeong, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/447,105

(22) Filed: Jun. 6, 2006

(30) Foreign Application Priority Data
Jun. 25, 2005 (KR) 2005-55414

(51) Int. Cl. B41J 2/205

(52) U.S. Cl. 347/15

(57) ABSTRACT

An ink-jet image forming apparatus and a high resolution printing method capable of printing with a higher resolution than an actual resolution of a print head include selecting Q or P, printing data corresponding to a first pixel row of printing data while transferring a print head along a main scanning direction, printing data corresponding to a following pixel row by transferring a printing medium along a sub scanning direction by a distance of (P−1)*X+X/Q, and printing data corresponding to the following pixel row by transferring the printing medium along the sub scanning direction by a distance of (N−P)*X+X/Q where N denotes the number of nozzles, P denotes an any number less than N, X denotes a distance between the nozzles, and Q denotes a multiple number of a resolution.

### CROSS-REFERENCE TO RELATED APPLICATIONS

This application claims the benefit under 35 U.S.C. §119 of Korean Patent Application No. 2005-55414, filed on Jun. 25, 2005, in the Korean Intellectual Property Office, the disclosure of which is incorporated herein in its entirety by reference.

### BACKGROUND OF THE INVENTION

1. Field of the Invention

The present general inventive concept relates to an ink-jet image forming apparatus, and more particularly, to an ink-jet image forming apparatus and a high resolution printing method capable of printing an image with a higher resolution than an actual resolution of a print head.

2. Description of the Related Art

In an ink-jet image forming apparatus, such as a printer and a multi-functional apparatus, there is a difference in resolution according to a type thereof. For example, the resolution can be 300 dpi or 600 dpi. In order to print an image with a resolution of 600 dpi, a host creates image data corresponding to the resolution of 600 dpi using a printer driver and stores the image data in a memory. When the host transfers the image data to a printer, the printer receives the image data stored in the memory and transfers a print head to a printing start position to perform a printing operation. In this case, a printer with a resolution of 600 dpi requires a memory capacity four times larger than a printer with a resolution of 300 dpi. In addition, a data transfer time for the printer with the resolution of 600 dpi is four times a data transfer time for the printer with the resolution of 300 dpi. These differences in the memory capacity and the data transfer time have a significant effect on a printing performance of the respective printers. In addition, because a font used to print an image with a resolution of 300 dpi cannot be used as it is, a new font is created to correspond to an image having the 600 dpi resolution, and because the new font data is stored in a memory, manufacturing costs increase.

A technology that can print an image with a high resolution, such as 600 dpi, by a printer having a low resolution, such as 300 dpi, is disclosed in U.S. Pat. No. 5,469,198 titled as “Multiple pass printing for achieving increased print resolution.” FIG. 1 is a view illustrating a conventional process in which data corresponding to a pixel row is printed by a nozzle array having a nozzle pitch which is two times of a pitch of the pixel row. A carriage scan is a sequence of data corresponding to a pixel row, which is printed toward a carriage transfer direction. When printing information is indicated with a pixel unit array, a row corresponding to the printing information thereof is referred to as a pixel row. FIG. 1 shows 16 pixel rows.

First, in order to adjust a printing start position, a printing medium is transferred by a distance of a (2M−1) pixel row, and a first scanning along the carriage transfer direction (the carriage scan direction) is performed to print data corresponding to a first pixel row. Here, M denotes a number less than a nozzle number N, and in the case of FIG. 1, M is 2. Next, the printing medium is transferred by a distance of a 2 (N−M)+1 pixel row, and a second scanning along the carriage transfer direction is performed to print data corresponding to a second pixel row. Next, the printing medium is transferred by a distance of a (2M−1) pixel row, and a third scanning along the carriage transfer direction is performed to print data corresponding to a third pixel row. Such a printing process after transferring is repeated until all data is printed. In this manner, it is possible to print with as high as twice of a resolution of a printer.

However, a multiple number of the resolution is limited to only two times the actual resolution, and thus there is a limitation in that printing with a higher resolution is not achieved. In addition, in order to adjust the printing start position, a transferring distance of the printing medium must be known from the beginning of the printing process.

### SUMMARY OF THE INVENTION

The present general inventive concept provides an ink-jet image forming apparatus and a high resolution printing method capable of printing an image with a higher resolution than an actual resolution of a print head while transferring a printing medium according to a predetermined rule.

Additional aspects and advantages of the present general inventive concept will be set forth in part in the description which follows and, in part, will be obvious from the description, or may be learned by practice of the general inventive concept.

The foregoing and/or other aspects of the present inventive concept may be achieved by providing a high resolution printing method comprising selecting Q or P, printing data corresponding to a first pixel row of printing data on a printing medium while transferring a print head along a main scanning direction, printing data corresponding to a following pixel row by transferring the printing medium along a sub scanning direction by a distance of (P−1)*X+X/Q, and printing data corresponding to the following pixel row by transferring the printing medium along the sub scanning direction by a distance of (N−P)*X+X/Q where N denotes the number of nozzles, P denotes an any number of less than N, X denotes a distance between the nozzles, and Q denotes a multiple number of a resolution. The printing operation of the data corresponding to the following pixel row may be repeated when data corresponding to another pixel row to be printed remains. The printing operation of the data corresponding to the first pixel row may print the data corresponding to the first pixel row by ink from a P nozzle among the N nozzles.

The foregoing and/or other aspects of the present inventive concept may also be achieved by providing a high resolution printing method comprising selecting Q or P, printing data corresponding to a first pixel row of the printing data on a printing medium while transferring the print head along a main scanning direction, printing data corresponding to a following pixel row by transferring the printing medium along a sub scanning direction by a distance of (P−1)*X+X/Q, printing data corresponding to the following pixel row by transferring the printing medium along the sub scanning direction by a distance of X/Q, and printing data corresponding to the following pixel row by transferring the printing medium along the sub scanning direction by a distance of (N−P)*X+X/Q where N denotes the number of nozzles, P denotes an any number of less than N, X denotes a distance between the nozzles, and Q denotes a multiple number of a resolution. The printing operation of the data corresponding to the following pixel row may be repeated (Q−2) times when Q is greater than 4.

The foregoing and/or other aspects of the present inventive concept may also be achieved by providing an ink-jet image forming apparatus comprising a print head having a nozzle unit having N nozzles disposed along a sub scanning direction, a printing medium transfer unit to transfer a printing medium along the sub scanning direction, a control unit to control operations of the print head and the printing medium transfer unit, so that ink is ejected from the print head at a desirable portion of the printing medium, and a user interface unit to display an environment where a user can select Q or P, wherein the control unit prints data corresponding to a first pixel row of the printing data using the N nozzles while transferring the print head along a main scanning direction, prints data corresponding to a following pixel row by transferring a printing medium along the sub scanning direction by a distance of (P−1)*X+X/Q, and prints data corresponding to the following pixel row by transferring the printing medium along the sub scanning direction by a distance of (N−P)*X+X/Q where N denotes the number of nozzles, P denotes an any number of less than N, X denotes a distance between the nozzles, and Q denotes a multiple number of a resolution.

The foregoing and/or other aspects of the present inventive concept may also be achieved by providing an ink-jet image forming apparatus comprising a print head having a nozzle unit having N nozzles disposed along a sub scanning direction, a printing medium transfer unit to transfer a printing medium along the sub scanning direction, a control unit to control operations of the print head and the printing medium transfer unit, so that ink is ejected from the print head at a desirable portion of the printing medium, and a user interface unit to display an environment where a user can select Q or P, wherein the control unit prints data corresponding to a first pixel row of the printing data using the N nozzles while transferring the print head along a main scanning direction, prints data corresponding to a following pixel row by transferring a printing medium along the sub scanning direction by a distance of (P−1)*X+X/Q, prints the printing medium along the sub scanning direction by a distance of X/Q, and prints data corresponding to the following pixel row by transferring the printing medium along the sub scanning direction by a distance of (N−P)*X+X/Q where N denotes the number of nozzles, P denotes an any number of less than N, X denotes a distance between the nozzles, and Q denotes a multiple number of a resolution.

The foregoing and/or other aspects of the present inventive concept may also be achieved by providing an image forming apparatus comprising a print head having a nozzle unit having N nozzles disposed along a sub scanning direction and moving a main scanning direction to print data on a printing medium, a printing medium transfer unit to transfer the printing medium along the sub scanning direction, a user interface to select a number less than the number of nozzles and a resolution number, and a control unit to control the print head to print first data corresponding to first pixel rows, to print second data corresponding to second pixel rows after the printing medium transfer unit transfers the printing medium by a first distance determined according to the number less than the number of the nozzles, a pitch of the nozzles, and the resolution number, and to print third data corresponding to third pixel rows after the printing medium transfer unit transfers the printing medium by a second distance determined according to the number of the nozzles, the number less than the number of the nozzles, a pitch of the nozzles, and the resolution number.

The foregoing and/or other aspects of the present inventive concept may also be achieved by providing an image forming apparatus comprising a print head having a nozzle unit with nozzles disposed along a sub scanning direction, a printing medium transfer unit to transfer a printing medium along the sub scanning direction by a first distance determined according to a number less than the number of the nozzles, a pitch of the nozzles, and a resolution number, and a second distance determined according to the number of the nozzles, the number less than the number of the nozzles, the pitch of the nozzles, and the resolution number, and a control unit to control the print head to move along the sub scanning direction to print data on the printing medium, and to control the printing medium transfer unit to transfer the printing medium along the sub scanning direction according to the first distance and the second distance to print data using the print head.

The foregoing and/or other aspects of the present inventive concept may also be achieved by providing an image forming apparatus comprising a print head having a nozzle unit with nozzles disposed along a sub scanning direction, a printing medium transfer unit to transfer a printing medium along the sub scanning direction by a first distance determined according to a pitch of the nozzles and a resolution number, and a second distance determined according to the number of nozzles, a number less than the number of the nozzles, the pitch of the nozzles, and the resolution number, and a control unit to control the print head to move along the sub scanning direction to print data on the printing medium, and to control the printing medium transfer unit to transfer the printing medium along the sub scanning direction according to the first distance and the second distance to print data using the print head.

The foregoing and/or other aspects of the present inventive concept may also be achieved by providing an image forming apparatus comprising a print head having a nozzle unit with nozzles disposed along a sub scanning direction, a printing medium transfer unit to transfer a printing medium along the sub scanning direction by a distance determined according to the number of nozzles, a number less than the number of the nozzles, a pitch of the nozzles, and a resolution number, and a control unit to control the print head to move along the sub scanning direction to print data on the printing medium, and to control the printing medium transfer unit to transfer the printing medium along the sub scanning direction according to the distance to print data using the print head.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a view illustrating a conventional method of printing data corresponding to a pixel row;

FIG. 2 is a structural block diagram of an ink-jet image forming apparatus according to an embodiment the present general inventive concept;

FIG. 3 is a flowchart illustrating a high resolution printing method of an ink-jet image forming apparatus according to an embodiment of the present general inventive concept;

FIG. 4 is a flowchart illustrating operation S350 of the high resolution printing method illustrated in FIG. 3;

FIGS. 5A and B are views respectively illustrating rows of pixels printed in an image forming apparatus using a high resolution printing method according to embodiments of the present general inventive concept; and

FIGS. 6A and 6B are views respectively illustrating pixel rows printed in an image forming apparatus using a high resolution printing method according to embodiments of the present general inventive concept.

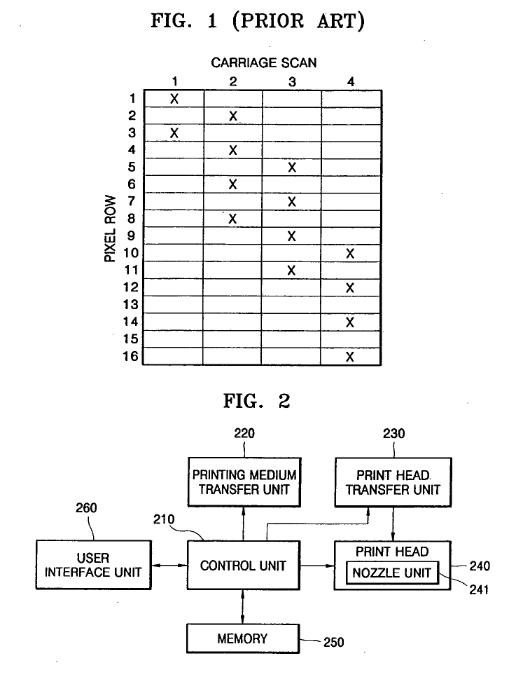

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

FIG. 2 is a block diagram of an ink-jet image forming apparatus according an embodiment of the present general inventive concept.

Referring to FIG. 2, the ink-jet image forming apparatus includes a control unit 210, a printing medium transfer unit 220, a print head transfer unit 230, a print head 240, a memory 250, and a user interface unit 260. The print head 240 includes a nozzle unit 241 having N nozzles disposed along a sub scanning direction (or a printing medium transferring direction.

The control unit 210 controls operations of the printing medium transfer unit 220 and the print head transfer unit 230 so that ink dispersed (or ejected) from the print head 240 can be deposited at a target portion on a printing medium. The printing medium transfer unit 220 transfers the printing medium in the sub scanning direction. The print head transfer unit 230 transfers the print head 240 in a main scanning direction forwardly and backwardly. The main scanning direction may be a direction along which the print head moves, and may be a direction parallel to the sub scanning direction.

The print head 240 includes the nozzle unit 241 to print an image by ejecting ink onto the printing medium and is installed to be transferable in the main scanning direction. The print head 240 uses a heat energy source or a piezoelectric element as a power source for ejecting the ink.

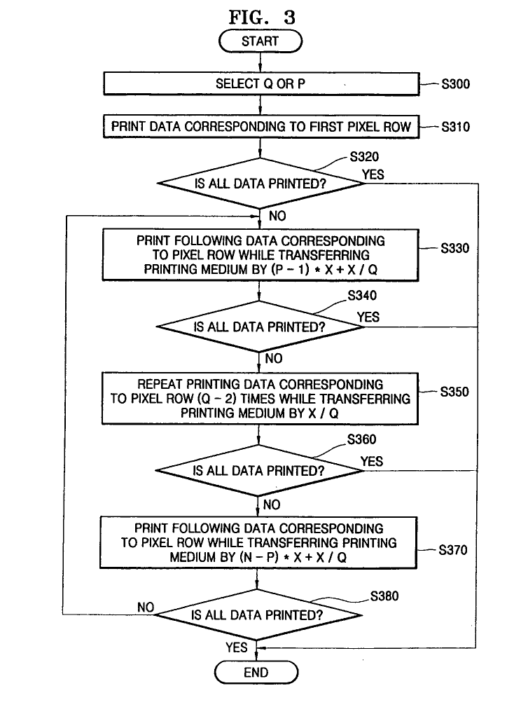

The control unit 210 controls the memory 250 to store printing data input through a PC, a notebook computer, a PDA, and a data input device, such as a host (not shown). The user interface unit 260 displays an environment where a user can select a multiple number of a resolution Q (Q=2, 3, . . . , n) and P (P is any number of less than the number of nozzles N). Operations of structural elements of such an image forming apparatus will be described in detail referring to FIG. 3.

FIG. 3 is a flowchart illustrating a high resolution printing method of an ink-jet image forming apparatus according to an embodiment of the present general inventive concept.

Referring FIGS. 2 and 3, in operation S300, a user selects a multiple number of a resolution Q and P through the user interface unit 260.

In operation S310, while the print head transfer unit 230 transfers the print head 240 along the main scanning direction, the print head 240 ejects ink through the N nozzles and prints first data corresponding to a first pixel row of printing data. Here, the print head 240 ejects ink from a position corresponding to a Pth nozzle among the N nozzles when printing the data corresponding to the first pixel row. This is to set a printing start position with a desirable resolution when P is greater than 2. In operation S320, it is determined whether all the data is printed.

In operation S330, the printing medium transfer unit 220 transfers the printing medium along the sub scanning direction by a distance of (P−1)*X+X/Q, and the print head 240 prints data corresponding to a following pixel row. Here, X denotes a distance (or a nozzle pitch) between the nozzles. In operation S340, it is determined whether or not all printing data is printed, and if all printing data is printed, printing operation is complete. If all printing data is not printed, operation S350 is performed.

In operation S350, the printing medium transfer unit 220 transfers the printing medium along the sub scanning direction by a distance of X/Q, and the print head 240 prints data corresponding to a following pixel row. If Q is 2, operation S350 is not performed, if Q is 3, operation S350 is performed once, and if Q is greater than 4, operation S350 is repeated (Q−2) times. That is, the N nozzles may eject ink along respective following pixel rows in the main scanning direction.

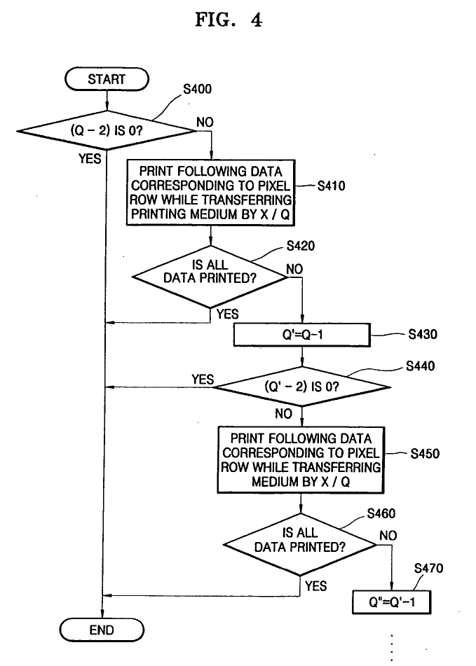

FIG. 4 is a flowchart illustrating operation S350 of the high resolution printing method of an ink-jet image forming apparatus of FIG. 3.

In operation S400, the control unit 210 determines whether or not (Q−2) is 0. If (Q−2) is 0, operation S360 is performed.

If (Q−2) is not 0, in operation 410, the printing medium transfer unit 220 transfers the printing medium toward the sub scanning direction by a distance of X/Q, and the print head 240 prints data corresponding to a following pixel row. In operation S420, it is determined whether or not all printing data is printed, and if all printing data is printed, printing operation is complete. If all printing data is not printed, operation S430 is performed.

In operation S430, it is determined to be Q′=Q−1. In operation S400, the control unit 210 determines whether or not (Q′−2) is 0. If (Q′−2) is not 0, operation S360 is performed.

If (Q′−2) is not 0, in operation 450, the printing medium transfer unit 220 transfers the printing medium along the sub scanning direction by a distance of X/Q, and the print head 240 prints data corresponding to another following pixel row. In operation S460, it is determined whether or not all printing data is printed, and if all printing data is printed, printing operation is complete. If all printing data is not printed, operation S470 is performed. In operation S470, it is determined to be QΔ=Q′−1. While repeating such operations, if Q is greater than 4, operation S350 is repeated (Q−2) times.

Referring back to FIG. 3, in operation S360, it is determined whether or not all printing data is printed, and if all printing data is printed, printing operation is complete. If all printing data is not printed, operation S370 is performed.

In operation S370, the printing medium transfer unit 220 transfers the printing medium toward the sub scanning direction by a distance of (N−P)*X+X/Q, and the print head 240 prints data corresponding to a following pixel row. In operation S380, it is determined whether or not all printing data is printed, and if all printing data is not printed, operation S330 is performed to continue printing operation. If all printing data is printed, printing operation is complete.

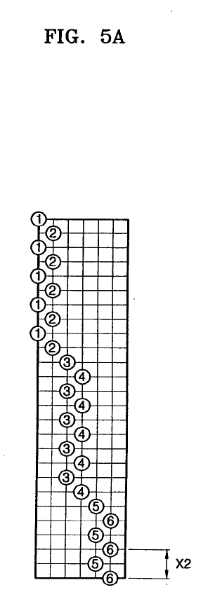

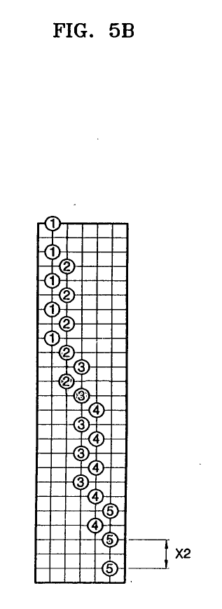

FIGS. 5A and 5B are views respectively illustrating rows of pixels printed in an image forming apparatus using a high resolution printing method of the image forming apparatus according to embodiments of the present general inventive concept.

Referring to FIG. 5A, it shows a case where N=5, P=1, Q=2, and X=X2. N=5 represents that there are five nozzles in the sub scanning nozzles which move in the main scanning direction. The five nozzles may eject ink on a printing paper along first pixel rows when the print head 240 moves along the main scanning direction. X represents a nozzle pitch between the adjacent nozzles, and X2 represents that at least one row is inserted and printed inside the nozzle pitch. After first data \textcircled{1} corresponding to the first pixel row (first pixel rows) is printed by using the five nozzles, the printing paper is transferred by a distance of X2/2, and second data \textcircled{2} corresponding to the second pixel row (second pixel rows) is printed. Since P=1, at a time when second data corresponding to the second pixel row is printed, a first nozzle of the five nozzles is disposed on a position between first and second rows of the first pixel rows to eject ink to form a first one of the second data \textcircled{2}. Since (Q−2) is 0, operation S350 is skipped. Next, the printing paper is transferred by a distance of 4*(X2)+(X2)/2, and third data \textcircled{3} corresponding to a third pixel row (third pixel rows) is printed. That is, second data \textcircled{2} are formed or disposed on positions corresponding to a next row of each first pixel row or between the adjacent first pixel rows corresponding to first data \textcircled{1}, and fourth data \textcircled{4} are disposed on positions corresponding to a next row of each third pixel row or between the adjacent third pixel rows corresponding to third data \textcircled{3}, as illustrated in FIG. 5A.

Referring to FIG. 5B, it shows a case where N=5, P=2, Q=2, and X=X2. After first data \textcircled{1} corresponding to the first pixel row (or first pixel rows) is printed on a printing paper by using the 5 nozzles, the printing paper is transferred by a distance of X2+X2/2, and second data \textcircled{2} corresponding to the second pixel row is printed. Since P=2, at a time when the second data \textcircled{2} corresponding to the second pixel row (second pixel rows) is printed, a first nozzle of the five nozzles is disposed on a position between second and third rows of the first pixel rows to inject ink to form a first one of the second data \textcircled{2}, and thus the printing start position is arranged for the second data \textcircled{2}. This is to print all printing data with a desirable resolution. Since (Q−2) is 0, operation S350 is not performed. Next, the printing paper is transferred by a distance of 3*(X2)+(X2)/2, and third data \textcircled{3} corresponding to a third pixel row (third pixel rows) is printed. That is, there is no printed data between the position between first and second rows of the first pixel rows corresponding to the first data \textcircled{1} since the first nozzle of the five nozzles is disposed on a position between the second and third rows of the first pixel rows, as illustrated in FIG. 5B. It is possible that a first column is not printed when printing the first data \textcircled{1} corresponding to the first pixel row (or first pixel rows) using the five nozzles moving in the main scanning direction. That is, the first data \textcircled{1} corresponding to the first pixel row (or first pixel rows is printed on a second column. It is also possible that the second data \textcircled{2} corresponding to the second pixel row (second pixel rows) is printed using nozzles between a P^{th} nozzle and the N^{th} nozzle of the N nozzles.

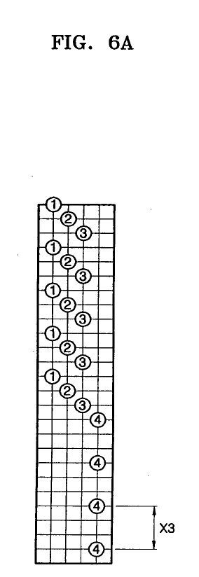

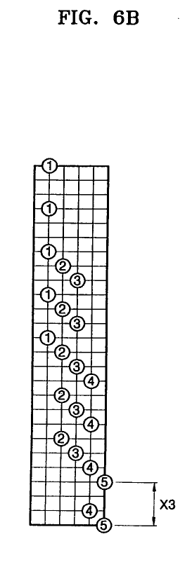

FIGS. 6A and 6B are views respectively illustrating rows of pixels printed in an image forming apparatus using a high resolution printing method of an image forming apparatus according to embodiments of the present general inventive concept.

Referring to FIG. 6A, it shows a case where N=5, P=1, Q=3, and X=X3. Since X represents a nozzle pitch between the adjacent nozzles, X3 represents that at least two rows are inserted and printed inside the nozzle pitch. After first data \textcircled{1} corresponding to the first pixel row (first pixel rows) is printed on a printing paper by using the five nozzles, the printing paper is transferred by a distance of X3/3, and second data \textcircled{2} corresponding to the second pixel row is printed. Since P=1, at a time when the second data \textcircled{2} corresponding to the second pixel row (second pixel rows) is printed, a first nozzle of the five nozzles ejects ink on a position between first and second rows of the first pixel rows. Since (Q−2) is 1, the printing paper is transferred by X3/3, and third data \textcircled{3} corresponding to a third pixel row is printed. This process is performed once. Next, the printing paper is transferred by a distance of 4*(X3)+(X3)/3, and fourth data \textcircled{4} corresponding to a fourth pixel row is printed. That is, second data \textcircled{2} are formed or disposed on positions corresponding to a next row of each first pixel row or between the adjacent first pixel rows corresponding to first data \textcircled{1}, and fourth data \textcircled{4} are disposed on positions corresponding to a next row of each third pixel row or between the adjacent third pixel rows corresponding to third data \textcircled{3}, as illustrated in FIG. 6A.

Referring to FIG. 6B, it shows a case where N=5, P=3, Q=3, and X=X3. After the first data \textcircled{1} corresponding to the first pixel row is printed on a printing paper by using the five nozzles, the printing paper is transferred by a distance of 2*(X3)+X3/3, and second data \textcircled{2} corresponding to the second pixel row is printed. Since P=3, at a time when the first data \textcircled{1} corresponding to the first pixel row is printed, a first nozzle of the five nozzles is disposed on a position between third and fourth rows of the first pixel rows to inject ink to form a first one of the second data \textcircled{2}, and thus the printing start position is arranged with respect to the third data \textcircled{3}. This is to print all printing data with a desirable resolution. Since (Q−2) is 1, the printing paper is transferred by a distance of X3/3, and the third data \textcircled{3} corresponding to a third pixel row is printed. This process is performed once. Next, the printing paper is transferred by a distance of 2*(X3)+(X3)/3, and the fourth data \textcircled{4} corresponding to a fourth pixel row is printed. That is, there is no printed between a position between first and second rows and a position between the second and third rows of the first pixel rows corresponding to the first data \textcircled{1} since the first nozzle of the five nozzles is not disposed on a position between first and second rows but a position between the third and fourth rows of the first pixel rows, as illustrated in FIG. 6B. Also, there is no printed between a position between first and second rows and a position between the second and third rows of the second pixel rows corresponding to the second data \textcircled{2} since the first nozzle of the five nozzles is not disposed on a position between the first and second rows but a position between the third and fourth rows of the second pixel rows.

Accordingly, in the present general inventive concept, since a printing medium is printed while being transferred along a sub scanning direction according to a predetermined rule, it is possible to print an image with as high as n times (n=2, 3, . . . ) of an actual resolution of a print head.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of printing data with a higher resolution than an actual resolution of a print head in an ink-jet image forming apparatus, the method comprising:
selecting Q or P;
printing data corresponding to a first pixel row of printing data on a printing medium while transferring a print head along a main scanning direction;
printing data corresponding to a following pixel row by transferring the printing medium along a sub scanning direction by a distance of (P−1)*X+X/Q; and
(printing data corresponding to the following pixel row by transferring the printing medium along the sub scanning direction by a distance of (N−P)*X+X/Q,
wherein N denotes the number of nozzles, P denotes any number of less than N, X denotes a distance between the nozzles, and Q denotes a multiple number of a resolution.

2. The method according to claim 1, wherein the printing operations of the data corresponding to the following pixel by transferring the printing medium by the distance of (P−1)*X+X/Q and (N−P)*X+X/Q are repeated when the data corresponding to the following pixel row to be printed remains.

3. The method according to claim 1, wherein the printing of the data corresponding to the following pixel row comprises printing the data corresponding to the following pixel row by ejecting ink on a position of the first pixel row corresponding to a P^{th} nozzle of the N nozzles.

4. A method of printing data with a higher resolution than an actual resolution of a print head in an ink-jet image forming apparatus, the method comprising:
selecting Q or P;
printing data corresponding to a first pixel row of the printing data while transferring the print head along a main scanning direction;
printing data corresponding to a following pixel row by transferring the printing medium along a sub scanning direction by (P−1)*X+X/Q;
printing data corresponding to a following pixel row by transferring the printing medium along the sub scanning direction by a distance of X/Q; and
printing data corresponding to a following pixel row by transferring the printing medium along the sub scanning direction by a distance of (N−P)*X+X/Q,
wherein N denotes the number of nozzles, P denotes any number of less than N, X denotes a distance between the nozzles, and Q denotes a multiple number of a resolution.

5. The method according to claim 4, wherein the printing operation of the data corresponding to the following pixel by transferring the printing medium by a distance of X/Q is repeated (Q−2) times when Q is greater than 4.

6. The method according to claim 4, wherein the printing operations of the data by transferring the printing medium by the distance of (P−1)*X+X/Q and X/Q are repeated when the data corresponding to the following pixel row to be printed remains.

7. The method according to claim 4, wherein the printing operation of the data corresponding to the first pixel row comprises printing the data corresponding to the following pixel row by ejecting ink on a position of the first pixel row corresponding to a P^{th} nozzle of the N nozzles.

8. An ink-jet image forming apparatus comprising:
a print head having a nozzle unit having N nozzles disposed along a sub scanning direction;
a printing medium transfer unit to transfer a printing medium along the sub scanning direction;
a control unit to control operations of the print head and the printing medium transfer unit, so that ink is ejected from the print head at a desirable portion of the printing medium; and
a user interface unit to display an environment according to a user selection of Q or P,
wherein the control unit controls the print head to print data corresponding to a first pixel row of the printing data while transferring the print head along a main scanning direction, to print data corresponding to a following pixel row by transferring a printing medium along the sub scanning direction by a distance of (P−1)*X+X/Q, and to print data corresponding to a following pixel row by transferring the printing medium along the sub scanning direction by a distance of (N−P)*X+X/Q,
wherein N denotes the number of nozzles, P denotes any number of less than N, X denotes a distance between the nozzles, and Q denotes a multiple number of a resolution.

9. The ink-jet image forming apparatus according to claim 8, wherein the control unit controls the print head to print data corresponding to the first pixel row by ejecting ink from a P^{th} nozzle of the N nozzles.

10. An ink-jet image forming apparatus comprising:
a print head having a nozzle unit having N nozzles disposed along a sub scanning direction;
a printing medium transfer unit to transfer a printing medium along the sub scanning direction;
a control unit to control operations of the print head and the printing medium transfer unit, so that ink is ejected from the print head at a desirable portion of the printing medium; and
a user interface unit to display an environment according to a user selection of Q or P,
wherein the control unit controls the print head to print data corresponding to a first pixel row of the printing data while transferring the print head along a main scanning direction, to print data corresponding to a following pixel row by transferring a printing medium along the sub scanning direction by a distance of (P−1)*X+X/Q, to print data corresponding to a following pixel row by transferring the printing medium along the sub scanning direction by a distance of X/Q, and to print data corresponding to the following pixel row by transferring the printing medium along the sub scanning direction by a distance of (N−P)*X+X/Q,
wherein N denotes the number of nozzles, P denotes any number of less than N, X denotes a distance between the nozzles, and Q denotes a multiple number of a resolution.

11. The ink-jet image forming apparatus according to claim 10, wherein the control unit controls the print head to print the data corresponding to the following pixel row by ejecting ink on a position of the first pixel row corresponding to a P^{th} nozzle of the N nozzles.

12. An ink-jet image forming apparatus comprising:
a print head having a nozzle unit having N nozzles disposed along a sub scanning direction and moving a main scanning direction to print data on a printing medium;
a printing medium transfer unit to transfer the printing medium along the sub scanning direction;
a user interface to select a number less than the number of nozzles and a resolution number; and
a control unit to control the print head to print first data corresponding to first pixel rows, to print second data corresponding to second pixel rows after the printing medium transfer unit transfers the printing medium by a first distance determined according to the number less than the number of the nozzles, a pitch of the nozzles, and the resolution number, and to print third data corresponding to third pixel rows after the printing medium transfer unit transfers the printing medium by a second distance determined according to the number of the nozzles, the number less than the number of the nozzles, a pitch of the nozzles, and the resolution number.

13. An image forming apparatus comprising:
a print head having a nozzle unit with nozzles disposed along a sub scanning direction;
a printing medium transfer unit to transfer a printing medium along the sub scanning direction by a first distance determined according to a number less than the number of the nozzles, a pitch of the nozzles, and a resolution number, and a second distance determined according to the number of the nozzles, the number less than the number of the nozzles, the pitch of the nozzles, and the resolution number; and
a control unit to control the print head to move along the sub scanning direction to print data on the printing medium, and to control the printing medium transfer unit to transfer the printing medium along the sub scanning direction according to the first distance and the second distance to print data using the print head.

14. The apparatus according to claim 13, wherein the first distance is determined according to (P−1)*X+X/Q where P is the number less than the number of nozzles, X is the nozzle pitch, and Q is the resolution number.

15. The apparatus according to claim 13, wherein the second distance is determined according to (N−P)*X+X/Q where N is the number of the nozzles, P is the number less than the number of the nozzles, X is the nozzle pitch, and Q is the resolution number.

16. The apparatus according to claim 13, wherein the printing medium transfer unit transfers the printing medium along the sub scanning direction by a third distance determined according to the nozzle pitch and the resolution number to print the data using the print head.

17. The apparatus according to claim 13, wherein the third distance is determined according to X/Q where X is the nozzle pitch, and Q is the resolution number.

18. The apparatus according to claim 13, wherein the data comprises first, second, and third data corresponding to one or more first pixel rows, one or more second pixel rows, and one or more third pixel rows, respectively, and the control unit controls the print head and the printing medium transfer unit such that the first data is printed on the first pixel rows, the second data is printed on the second pixel rows after transferring the printing medium by the first distance, and the third data is printed on the third pixel rows after transferring the printing medium by the second distance.

19. A method of an image forming apparatus, the method comprising:
transferring a printing medium along a sub scanning direction by a first distance determined according to a number less than the number of nozzles, a pitch of the nozzles, and a resolution number, and a second distance determined according to the number of the nozzles, the number less than the number of the nozzles, the pitch of the nozzles, and the resolution number; and
controlling a print head having a nozzle unit with nozzles disposed along a sub scanning direction to move along a main sub scanning direction to print data on the printing medium while transferring the printing medium along the sub scanning direction according to the first distance and the second distance.

20. An image forming apparatus comprising:
transferring a printing medium along a sub scanning direction by a distance determined according to the number of nozzles, a number less than the number of the nozzles, a pitch of the nozzles, and a resolution number; and
controlling a print head having a nozzle unit with the nozzles disposed along a sub scanning direction to move along a main sub scanning direction to print data on the printing medium while transferring the printing medium along the sub scanning direction according to the distance.
